(19) United States
(12) Patent Application Publication
(10) Pub. No.: US 2005/0008183 A1
(43) Pub. Date: Jan. 13, 2005

(54) Electronic device mount for mask

(76) Inventor: Greg Skillicorn, Grainger Township, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/846,203

(22) Filed: May 14, 2004

Related U.S. Application Data
(60) Provisional application No. 60/471,206, filed on May 16, 2003.

(51) Int. Cl. H04R 9/08; H04R 11/04

(52) U.S. Cl. 381/367; 381/364

(57) ABSTRACT

An adapter assembly for releasably supporting lapel mic on a mask includes a mask adapter for mounting on the mask, and a lapel adapter for mounting on the lapel mic. The lapel adapter is releasably connectable with the mask adapter to support the lapel mic on the mask. The adapter assembly has a sound opening that enables sound to pass from a voice emitter of the mask to the microphone of the lapel mic. The lapel connector of the lapel mic is accessible through the adapter assembly when the adapter assembly is connected with the lapel mic. The invention also relates to a method comprising the steps of attaching a lapel adapter to a lapel mic, attaching a mask adapter to a mask, and connecting the lapel mic to the mask.

### RELATED APPLICATIONS

This application claims the benefit of U.S. Provisional Application No. 60/471,206 filed May 16, 2003, the entire disclosure of which is incorporated by reference.

### FIELD OF THE INVENTION

The invention relates generally to communication systems, and more particularly, to mask-based communications. In particular, the invention relates to the mounting of a hand-held (or non-mask-supported) electrical device, such as a lapel mic (microphone), on a mask, so that a mask wearer can communicate electronically.

### BACKGROUND OF THE INVENTION

Protective gas masks or face masks provide breathing capabilities while protecting the mask user from noxious gases, smoke, etc. People wearing the masks often have a need to communicate with one another, particularly during emergency situations. To this end, police, fire, emergency medical service, security and military personnel often carry two-way radios as standard issue equipment. The two way radio often has connected to it a lapel mic, which is a microphone-speaker assembly hardwired to the radio with a coiled wire for releasable connection to the user's clothing via a lapel clip or lapel connector. Wearing a conventional gas mask or face mask in emergency situations can make the use of such standard issue two-way radios difficult or impossible because the masks cover, among other things, the wearer's mouth. Thus, the user's voice can not get out of the mask to the microphone of the male microphone. Alternatively, the user has to manually hold the lapel mic adjacent a voice emitter port of the mask.

### SUMMARY OF THE INVENTION

The present invention relates to an adapter assembly for use with a lapel mic that has a microphone and a speaker. The adapter assembly is for releasably supporting the lapel mic on a mask. The adapter assembly comprises a mask adapter for mounting on the mask, and a lapel adapter for mounting on the lapel mic. The lapel adapter is releasably connectable with the mask adapter to support the lapel mic on the mask.

The invention also relates to an adapter assembly for use with a lapel mic that has a lapel connector for releasably supporting the lapel mic on a wearer's lapel and that has a microphone and a speaker. The adapter assembly is for releasably supporting the lapel mic on a mask. The adapter assembly has a sound opening that enables sound to pass from the mask through the adapter assembly to the microphone of the lapel mic when the lapel mic is supported by the adapter assembly on the voice emitter port of the mask. The lapel connector of the lapel mic is accessible through the adapter assembly when the adapter assembly is connected with the lapel mic.

The invention also relates to apparatus comprising a mask having a voice emitter, a lapel mic having a lapel connector for releasably connecting the lapel mic to an article of clothing of a user, and an adapter assembly for releasably connecting the lapel mic with the mask. The lapel mic is alternatively connectable either with the mask by the adapter assembly or with the article of clothing by the lapel connector.

The invention also relates to a method comprising the steps of attaching a lapel adapter to a lapel mic, attaching a mask adapter to a mask, and connecting the lapel mic to the mask.

### BRIEF DESCRIPTION OF THE DRAWINGS

FIG. 1 is a schematic view showing an adapter assembly in accordance with a first embodiment of the invention, shown in use on a user with the lapel mic being supported on the user's lapel or other article of clothing;

FIG. 2 is a schematic view similar to FIG. 1 showing the adapter assembly of FIG. 1 in use on a user with the lapel mic being supported on the user's mask;

FIG. 3 is an exploded perspective view of the adapter assembly of FIG. 1;

FIG. 4 is a perspective view of a lapel adapter that forms part of the adapter assembly of FIG. 1, shown mounted on the lapel mic;

FIG. 5 is a side elevational view of the lapel adapter and the lapel mic;

FIG. 6 is an elevational view of the lapel adapter on the lapel mic;

FIG. 7 is an exploded perspective view of an adapter assembly in accordance with a second embodiment of the invention, shown associated with a lapel mic;

FIG. 8 is another exploded perspective view of the adapter assembly of FIG. 7, with the lapel adapter mounted on the lapel mic;

FIG. 9 is a perspective view of an adapter assembly in accordance with a third embodiment of the invention shown associated with a lapel mic; and

FIG. 10 is a view of the adapter assembly of FIG. 9 assembled with the lapel mic.

### DETAILED DESCRIPTION OF ILLUSTRATED EMBODIMENTS

The invention relates generally to communication systems, and more particularly, to mask-based communications. In particular, the invention relates to the mounting of a hand-held (or non-mask-supported) electrical device, such as a lapel mic, on a mask, to facilitate mask communication. The invention is applicable to mask communication devices of various types, including adapter assemblies for supporting lapel mics on masks, of various different types and constructions. The invention is not limited to the following description or the illustrated embodiments.

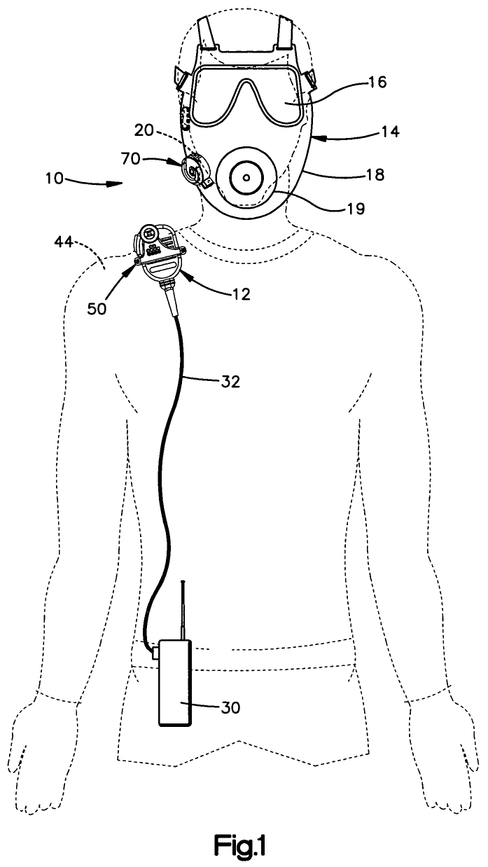

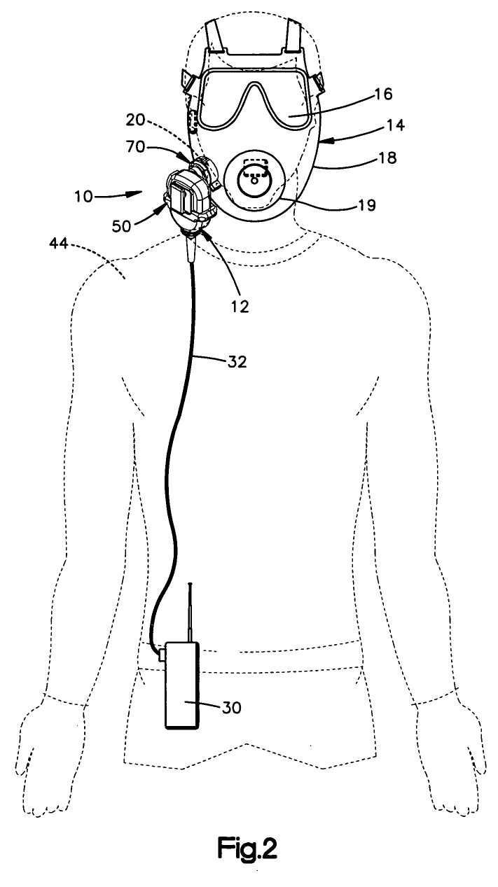

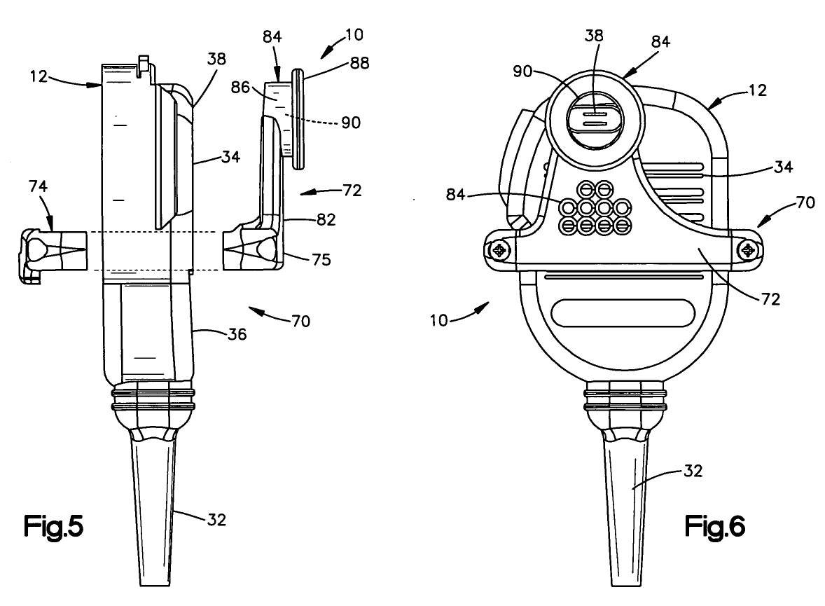

As representative of the invention, FIGS. 1-7 illustrate an adapter assembly 10 in accordance with a first embodiment of the invention, for supporting a lapel mic 12 on a mask 14. The mask 14 has a lens 16 through which the user can see. The mask 14 is coupled to the user's face by a seal 18 around the outside of the lens 16. The mask 14 covers the user's nose and mouth. The mask 14 has a breathing port 19 through which fresh air or oxygen can be admitted to the mask.

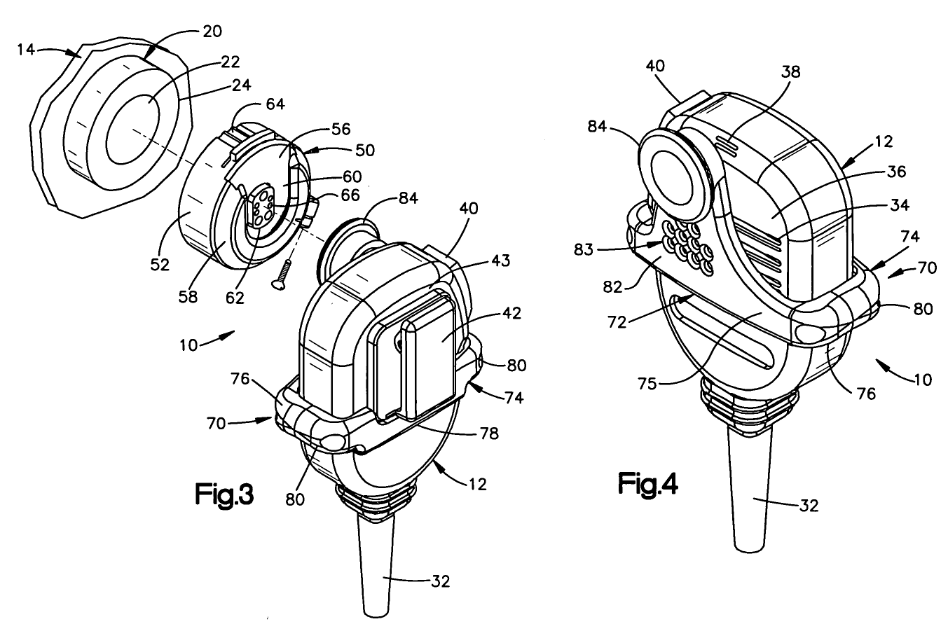

The mask 14 (FIGS. 1-3) also has one or more voice emitter ports 20. Each voice emitter port 20 includes an opening in the mask 14 that is sealed by a diaphragm 22 through which the user's voice can be projected to the outside of the mask. The voice emitter port 20 is surrounded by a circular closure member 24 (FIG. 3).

The lapel mic 12 is a known device that is attached to a walkie talkie 30 by, for example, a coiled wire 32. The lapel mic 12 may alternatively have a wireless link with the walkie talkie 30. The lapel mic 12 has a speaker grille (opening) 34 along its front major side surface 36, through which incoming signals to the lapel mic are broadcast for the user to hear. The lapel mic 12 has a microphone 38 which is located typically at an upper corner of the lapel mic, at the edge of the front surface 36. The microphone 38 picks up the user's voice and transmits it through the coiled wire 32. The lapel mic 12 also has a push to talk button 40, typically on a side of the lapel mic. The lapel mic 12 further includes a belt clip or lapel clip 42 which is a known clip on the back major side surface 43 for attaching the lapel mic to, for example, a lapel or pocket of other item 44 of the wearer's clothing as shown in FIG. 1.

The adapter assembly 10 as illustrated in FIGS. 1-7 includes two components: a mask adapter 50 and a lapel adapter 70. As described below, the mask adapter 50 is a device that attaches to the mask 14. The lapel microphone adapter or lapel adapter 70 is a device that attaches to the lapel mic 12. The lapel (microphone) adapter 70 is releasably engageable with the mask adapter 50 to support the lapel mic 12 on the mask 14, while the lapel mic still can be attached (alternatively) to the user's clothing 44 in the usual manner with the lapel clip 42. The adapter assembly 10 thus enables the lapel mic 12 to be connected with, or attached to, or supported on, the mask 14. This attachment is preferably, though not necessarily, adjacent the voice emitter 20. This attachment enables the user's voice as transmitted through the mask to be captured by the microphone 38 of the lapel mic. As a result, a mask wearer can communicate electronically using existing equipment.

The mask adapter 50 has a main body portion 52 that clamps onto or is otherwise secured to the voice emitter port 20. For example, the mask adapter 50 may be secured to the voice emitter port by a screw clamp 54. A mask adapter in accordance with the invention could have a different configuration or construction and could be connected with another part of a mask, for example, a part other than the voice emitter.

The mask adapter 50 has a slot 56 that opens upward when the mask adapter is installed on the mask 14 and the mask is in use. The slot 56 is defined by a wall portion 58 of the mask adapter 50 that is spaced outwardly from the main body portion 52 with the slot between them. There is a generally U-shaped opening 60 into the slot 56. The mask adapter 50 has a latch 62 adjacent the slot 56, and a latch release member 64 that is manually engageable to release the latch.

The mask adapter 50 has a sound opening 66 through which sound from the voice emitter 20 can pass to a location outside the mask 14 and outside the mask adapter. In the illustrated embodiment, the sound opening 66 is formed as a plurality of small openings 68.

The lapel adapter 70 in the illustrated embodiment includes a first part 72 and a second part 74. A lapel adapter in accordance with the invention could have a different configuration or construction.

The first part 72 of the lapel adapter 70 has an elongate bar portion 75 with bent end portions 76 for engaging the second part 74. The second part 74 of the lapel adapter 70 has an elongate bar portion 78 with bent end portions 80 for engaging the end portions 76 of the first part 72 and for receiving fasteners.

The first part 72 of the lapel adapter 70 has a body portion 82 that extends upward (as viewed in FIG. 4) from the bar portion 75 and that has a sound opening 83 in it. The body portion 82 supports a projecting hub 84 that includes a hollow stem portion 86 and an annular disc portion 88. The hub 84 thus has a sound opening 90 through which sound can pass. The disc portion 88 is configured to fit into the slot 56 in the mask adapter 50.

The first part 72 of the lapel adapter 70 fits around the front surface 36 of the lapel mic 12. The second part 74 of the lapel adapter 70 fits around the back surface 43 of the lapel mic 12. The first and second parts 72 and 74 of the lapel adapter 70 are secured to each other by fasteners 92, such as a pair of screws, through their respective end portions 76 and 80.

When the lapel adapter 70 is thus mounted on the lapel mic 12, the sound opening 90 in the first part 72 of the lapel adapter overlies the speaker grille 34 of the lapel mic 12, so that the sound from the speaker can still be heard by the user even though the lapel adapter is secured to the lapel mic.

The hub 84 of the lapel adapter 70 is aligned with (overlies) the microphone 38 of the lapel mic 152. As a result, the user's voice can still be directed into the microphone 38 of the lapel mic 12, through the sound opening 90 in the hub 84 of the lapel adapter 70, even though the lapel adapter is secured to the lapel mic.

In addition, neither the first part 72 nor the second part 74 of the lapel adapter 70 covers the lapel clip 42 of the lapel mic 12, as can be seen from FIG. 3. The open space around the second part 74 of the lapel adapter 70 constitutes an opening through which the lapel clip is accessible. (A differently constructed lapel adapter might have a different type of opening, for example, one bounded on all sides.) Thus, the lapel clip 42 can still be used to clip the lapel mic 12 to the user's clothing 44 even though the lapel adapter is secured to the lapel mic. The push to talk switch 40 is also accessible even though the lapel adapter 70 is secured to the lapel mic 12

When the user wants to support the lapel mic 12 on the lapel 44 or other article of clothing, the lapel clip 42 is used for that purpose. The lapel clip 42 is accessible through the lapel adapter 70 and can be clipped onto a lapel, a shirt pocket, or another portion of the user's clothing, for example.

When the lapel mic 12 is clipped on with the lapel clip 42, the hub 84 projects outward, away from the user. The microphone 38 and speaker opening 34 of the lapel mic 12 are unobstructed by the lapel adapter 70. Also, the push to talk switch 40 is accessible for operation in the normal manner.

When the user wants to support the lapel mic 12 on the mask 14, in order to communicate when wearing a mask, the lapel mic is unclipped from the lapel 44. The assembly of the lapel adapter 70 and lapel mic 12 is then brought into position adjacent the voice emitter port 20 of the mask 14. The hub 84 on the lapel adapter 70 is slipped into the slot 56 on the mask adapter 50. The latch 62 on the mask adapter 50 engages the hub 84 of the lapel adapter 70, to secure the lapel adapter to the mask adapter.

When the adapter assembly 10 is in this assembled condition, the sound opening 90 in the hub 84 of the lapel adapter 70 aligns with, or overlies, the sound opening 66 in the mask adapter 50. As a result, sound from the voice emitter 20 can pass through the sound opening 66 in the mask adapter 50, through the sound opening 90 in the lapel adapter 70, and into the microphone 38 of the lapel mic 12. Therefore, the user's voice is transmitted into the microphone 38 of the lapel mic 12, and the lapel mic is usable in the same manner as when it is on the lapel 44. At the same time, sound from the speaker grille 34 can pass through the sound opening 83 in the lapel adapter 70, to the wearer.

When the adapter assembly 10 is in this assembled condition, the hub 84 of the lapel adapter 70 can swivel in the slot 56 of the mask adapter 50. As a result, the lapel mic 12 can swivel with respect to the mask 14, and so will not drag on the coil cord 32, for example. Also, the swivel connection enables the lapel mic 12 to be attached to a voice emitter port 20 on either side of the mask 14, or to another portion of the mask.

When the user thereafter wants to have the lapel mic 12 on the lapel 44, the user actuates the latch release button 63, the latch 62 is released, and the user can lift the lapel adapter 70 out of the slot 56 in the mask adapter 50. The lapel mic 12 comes off the mask 14 along with the lapel adapter 70, and the assembly of the lapel mic and the lapel adapter can be hand held again or can be clipped to the clothing 44, for example.

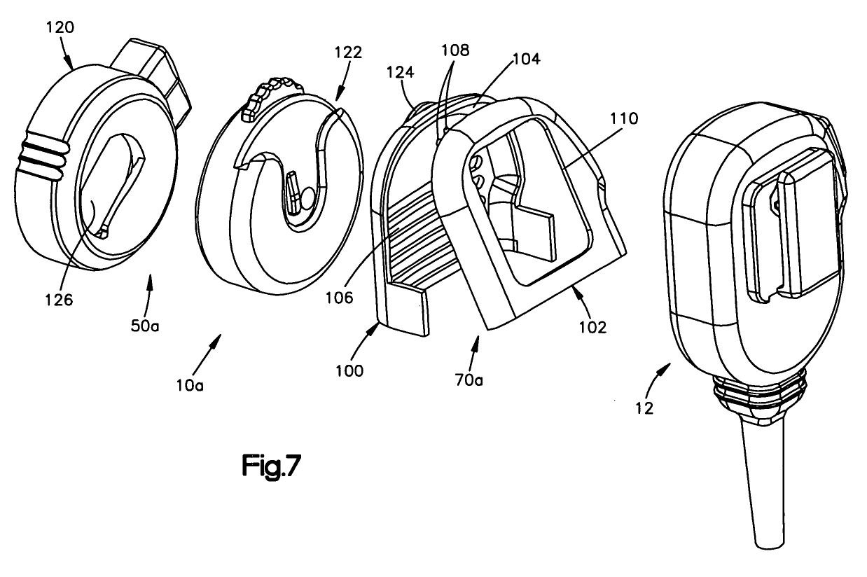

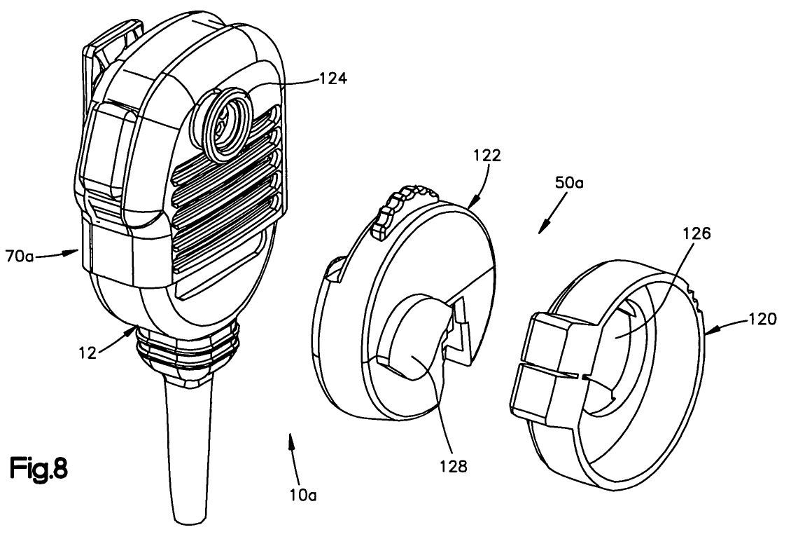

FIGS. 7 and 8 illustrate an adapter assembly 10a in accordance with a second embodiment of the invention. The adapter assembly 10a of the second embodiment is adapted to mount to the same lapel mic 12 and mask 14. The second embodiment illustrates, among other things, that the invention can be used with a known mask connector.

The lapel adapter 70a shown in FIGS. 7 and 8 is a one piece device rather than two pieces. The lapel adapter has a generally clamshell configuration including a first portion 100 and a second portion 102 joined by a hinge 104. The first portion 100 extends over the speaker side of the lapel mic 12 and has an opening or openings 106 for the speaker grille of the lapel mic 12. The first portion 100 also has an opening or openings 108 for the microphone of the lapel mic 12. The second portion 102 of the lapel adapter 70a extends over the back and has an opening 110 for the lapel clip.

The mask adapter 50a shown in FIGS. 7 and 8 is a two piece device rather than a one piece device. Thus, the mask adapter 50a has a first portion 120 that is adapted to be secured to a mask, and a second portion 122 that is adapted to receive a hub 124 of the lapel adapter 70a. The first portion 120 of the mask adapter 50a has a D-shaped opening 126 that is of the type used in some standard (known) mask connections, for example, for voice amplifiers. The second portion 122 of the mask adapter 50a has a D-shaped hub 124 that is adapted to fit into the D-shaped opening 126 with a known turn-and-lock action.

Thus, when the first portion 120 of the mask adapter 50a is on the mask, the mask either can receive the second portion 122 of the mask adapter and the lapel mic 12, or can receive another known device, such as a voice amplifier.

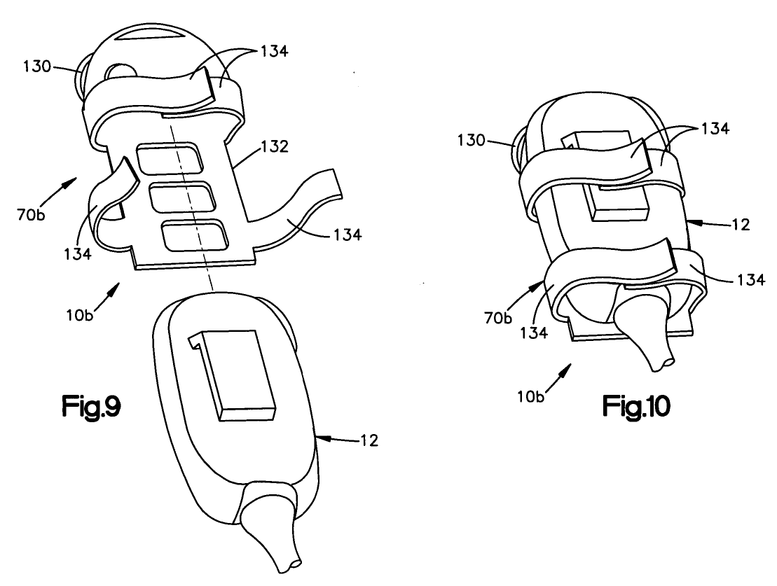

FIGS. 9 and 10 illustrate an adapter assembly 10b in accordance with a third embodiment of the invention. The adapter assembly 10b of the second embodiment is adapted to mount to the same lapel mic 12 and mask 14.

The adapter assembly 10b includes a lapel adapter 70b that is a one piece device having a D-shaped hub 130 similar to that of the mask adapter 50a of FIGS. 7 and 8. As a result, the lapel adapter 70b can mount directly to, for example, the first portion 102 of the mask adapter 50a shown in FIG. 7. The lapel adapter 70b is a one-piece unit that is basically a plate 132 with straps 134 to hold it onto the lapel mic 12. On the back is the D-shaped hub 130.

1. An adapter assembly for use with a lapel mic that has a microphone and a speaker, said adapter assembly for releasably supporting the lapel mic on a mask, said adapter assembly comprising:
a mask adapter for mounting on the mask; and
a lapel adapter for mounting on the lapel mic, said lapel adapter being releasably connectable with said mask adapter to support the lapel mic on the mask.

2. An adapter assembly as set forth in claim 1 for use with a lapel mic that has a lapel connector for releasably supporting the lapel mic, and wherein the lapel connector of the lapel mic is accessible when said lapel adapter is mounted on the lapel mic.

3. An adapter assembly as set forth in claim 1 wherein said mask adapter and said lapel adapter have respective sound openings that enable sound to pass from the mask through said adapter assembly to the microphone of the lapel mic when the lapel mic is supported on the mask.

4. An adapter assembly as set forth in claim 3 wherein said sound opening in said lapel adapter is in a connector portion of said lapel adapter that connects said lapel adapter to said mask adapter.

5. An adapter assembly as set forth in claim 1 wherein said lapel adapter is releasably connectable with said mask adapter by a swivel connection.

6. An adapter assembly as set forth in claim 1 wherein said mask adapter is adapted to engage a voice emitter of the mask.

7. An adapter assembly as set forth in claim 6 wherein said lapel adapter is releasably connected with said mask adapter by a swivel connection.

8. An adapter assembly as set forth in claim 1 wherein said mask adapter includes a latching mechanism for latching said lapel adapter into connection with said mask adapter.

9. An adapter assembly as set forth in claim 1 for use with a lapel mic that has a lapel connector for releasably supporting the lapel mic, and wherein the lapel connector of the lapel mic is accessible when said lapel adapter is mounted on the lapel mic;
wherein said mask adapter and said lapel adapter have respective sound openings that enable sound to pass from the mask through said adapter assembly to the microphone of the lapel mic when the lapel mic is supported on the mask, said sound opening in said lapel adapter being in a connector portion of said lapel adapter that connects said lapel adapter to said mask adapter.

10. An adapter assembly as set forth in claim 9 wherein said lapel adapter is releasably connectable with said mask adapter by a swivel connection and said mask adapter is adapted to engage a voice emitter of the mask.

11. An adapter assembly for use with a lapel mic that has a lapel connector for releasably supporting the lapel mic on a wearer's lapel and that has a microphone and a speaker, said adapter assembly for releasably supporting the lapel mic on a mask;
said adapter assembly having a sound opening that enables sound to pass from the mask through said adapter assembly to the microphone of the lapel mic when the lapel mic is supported by said adapter assembly on the mask;
the lapel connector of the lapel mic being accessible through said adapter assembly when said adapter assembly is connected with the lapel mic.

12. An adapter assembly as set forth in claim 11 comprising a swivel connection for supporting the lapel mic on the mask.

13. An adapter assembly as set forth in claim 12 wherein said swivel connection includes said sound opening of said adapter assembly.

14. An adapter assembly as set forth in claim 11 including a latching mechanism for latching the lapel mic onto the mask.

15. An adapter assembly as set forth in claim 11 comprising a lapel adapter and a mask adapter that are connected by a swivel connection.

16. An adapter assembly as set forth in claim 15 including a latching mechanism for latching said lapel adapter into connection with said mask adapter.

17. An adapter assembly as set forth in claim 16 wherein said mask adapter includes said latching mechanism.

18. Apparatus comprising:
a mask;
a lapel mic having a lapel connector for releasably connecting said lapel mic to an article of clothing of a user; and
an adapter assembly for releasably connecting said lapel mic with said mask;
said lapel mic being alternatively connectable either with said mask by said adapter assembly or with the article of clothing by said lapel connector.

19. Apparatus as set forth in claim 18 wherein said adapter assembly includes:
a first device that is mountable on said lapel mic and that does not impair connection of said lapel mic with the article of clothing and that does not impair usage of said lapel mic when said lapel mic is connected with the article of clothing; and
a second device that is mountable on said mask and that does not impair usage of said mask.

20. Apparatus as set forth in claim 19 wherein said first device has a connector portion that is releasably connectable with said second device to support said lapel mic on said mask.

21. Apparatus as set forth in claim 20 wherein said connector portion of said first device has a sound opening.

22. Apparatus as set forth in claim 21 wherein said lapel mic has a microphone and said adapter assembly has a sound opening for enabling transmission of sound from said mask to said microphone when said lapel mic is connected with said mask by said adapter assembly.

23. A method comprising the steps of:
attaching a lapel adapter to a lapel mic;
attaching a mask adapter to a mask; and
connecting the lapel mic to the mask.

24. A method as set forth in claim 23 wherein said step of connecting the lapel mic to the mask comprises connecting the lapel adapter to the mask adapter.

25. A method as set forth in claim 24 wherein said step of connecting the lapel adapter to the mask adapter comprises releasably connecting the lapel adapter to the mask adapter with a swivel connection.

26. A method as set forth in claim 23 wherein said step of attaching a mask adapter to a mask comprises attaching a mask adapter to a voice emitter port of a mask.

27. A method as set forth in claim 23 wherein said step of attaching a lapel adapter to a lapel mic comprises placing a sound opening of the lapel adapter over a microphone of the lapel mic, and wherein said step of attaching a mask adapter to a mask comprises placing a sound opening of the mask adapter over a voice emitter of the mask.
